(19) United States
(12) Patent Application Publication
(10) Pub. No.: US 2004/0227367 A1
(43) Pub. Date: Nov. 18, 2004

(54) Tarp claw

(76) Inventor: Gary Conner, Morongo Valley, CA (US)

Correspondence Address: CHRISTIE, PARKER & HALE, LLP, PO BOX 7068, PASADENA, CA, 91109-7068, US

(21) Appl. No.: 10/439,412

(22) Filed: May 15, 2003

(51) Int. Cl. B66C 1/26

(52) U.S. Cl. 294/82.31

(57) ABSTRACT

Described is a hoist assembly for transporting objects using a tarpaulin. In one embodiment, the hoist assembly includes a frame to which two or more fasteners are connected. The fasteners are configured so that the release of at least one of the fasteners is controlled and at least one of the fasteners does not release when the other fasteners are released.

### BACKGROUND OF THE INVENTION

1. Field of the Invention

The invention pertains to hoists and, more particularly, to a hoist capable of lifting objects using a tarpaulin.

2. Description of the Prior Art

Landscaping often results in the generation of cuttings and debris that must be removed. The removal of such debris is commonly achieved using manual labor to load the debris into the bed of a truck. The labor involved in loading a truck bed is time consuming and can result in injury or fatigue.

Cranes are commonly used as a labor saving device in the hoisting of objects. A typical crane will provide a hook to which a cargo net or tarpaulin can be attached. The tarpaulin and objects inside the tarpaulin can be lifted using the hook. Such a configuration enables the objects inside the tarpaulin to be set down by lowering the tarpaulin and then removing the tarpaulin from the hook. When the goods are not valuable, such as landscaping debris, it would be advantageous to be able to dump objects out of the tarpaulin in a controlled manner so that additional labor is not required to recover the tarpaulin, once the objects have been set down.

### SUMMARY OF THE INVENTION

The present invention provides a hoist assembly capable of loading objects into the bed of a truck with the assistance of a tarpaulin.

In one embodiment, the invention includes a frame and two or more fasteners connected to the frame. The fasteners are configured so that the release of at least one of the fasteners is controlled and at least one of the fasteners does not release when the other fasteners are released.

In a further embodiment, the frame includes a back plate to which at least one fastener is attached, a front plate pivotably attached to the back plate and to which at least one fastener is attached and a latch connected to the frame configured to hold the front plate against the back plate. The invention can also include a tarpaulin attached to the back plate and the front plate by the fasteners.

In another embodiment the fasteners are hooks, the tarpaulin includes a plurality of rings and the rings suspend the tarpaulin from the hooks on the front plate and the back plate. In an alternative embodiment, the front plate includes three hooks and the tarpaulin includes at least four rings. In addition, the latch may be pivotably connected to the frame and possesses a hook at one end that holds the front plate against the back plate. The frame may also include a latch lock that is configured to immobilize the latch.

A still further embodiment also includes a hoist arm having a sleeve and a lanyard extending through the sleeve and connected to the frame. This embodiment can also utilize a sleeve that is configured to release the latch lock when a portion of the frame is drawn inside the sleeve.

In yet another embodiment, the latch lock is connected to a solenoid configured to controllably release the latch lock.

A still further embodiment again includes a frame, first and second fastening means attached to the frame for suspending a tarpaulin and means for controllably releasing the second fastening means.

The method of the invention includes placing the object on a tarpaulin, fastening the tarpaulin to a hoist assembly having a plurality of fasteners, hoisting the hoist assembly and releasing some of the fasteners to enable the object to fall from the tarpaulin, while retaining the tarpaulin.

Yet another embodiment again includes a frame, a back plate connected to the frame and a front plate pivotably connected to the back plate. In addition, a latch is pivotably mounted on the frame and is configured to secure the front plate against the back plate. A latch lock pin is connected to the latch and a latch lock is pivotably mounted on the frame. The latch lock includes a notch configured to contain the latch lock pin. A spring is connected to the frame and to the latch lock, which is configured to resist movement of the latch lock when the latch lock pin is contained in the notch. At least one hook is connected to the back plate and at least one hook is connected to the front plate.

Other alternative embodiments of the invention are specifically adapted to hoist landscaping debris.

### BRIEF DESCRIPTION OF THE DRAWINGS

As can be seen in the drawings:

FIG. 1 is a perspective view of a hoist assembly in accordance with the invention;

FIG. 2 is a side view showing a portion of the hoist assembly inside a descending tube;

FIG. 3 is a front view of the hoist assembly;

FIG. 4 is a back view of the hoist assembly;

FIG. 5 is a perspective view showing a tarpaulin attached to a hoist assembly that is suspended from a crane arm via a crane cable, which passes through a descending tube; and

FIG. 6 is a side view of a hoist assembly in accordance with the invention that includes a solenoid.

### DETAILED DESCRIPTION OF THE INVENTION

The hoist assembly of the present invention includes a structure possessing fasteners from which a tarpaulin may be suspended. The fasteners are configured to enable the tarpaulin to be attached in a way that forms a cradle in which objects such as landscaping debris may be hoisted. The fasteners are also configured to release in a controllable fashion. When a loaded tarpaulin is attached to the fasteners, releasing some but not all of the fasteners will dump the contents of tarpaulin beneath the hoist assembly. The hoist assembly, therefore, enables objects including landscaping debris to be loaded onto a tarpaulin and then lifted and transported with ease using a crane or similar lifting device.

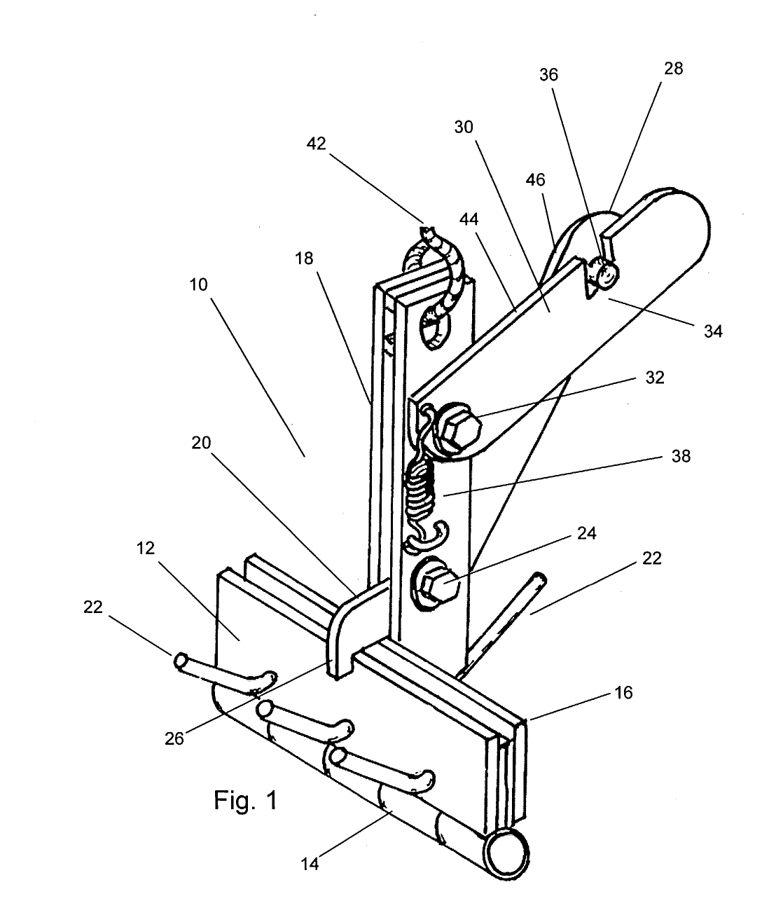

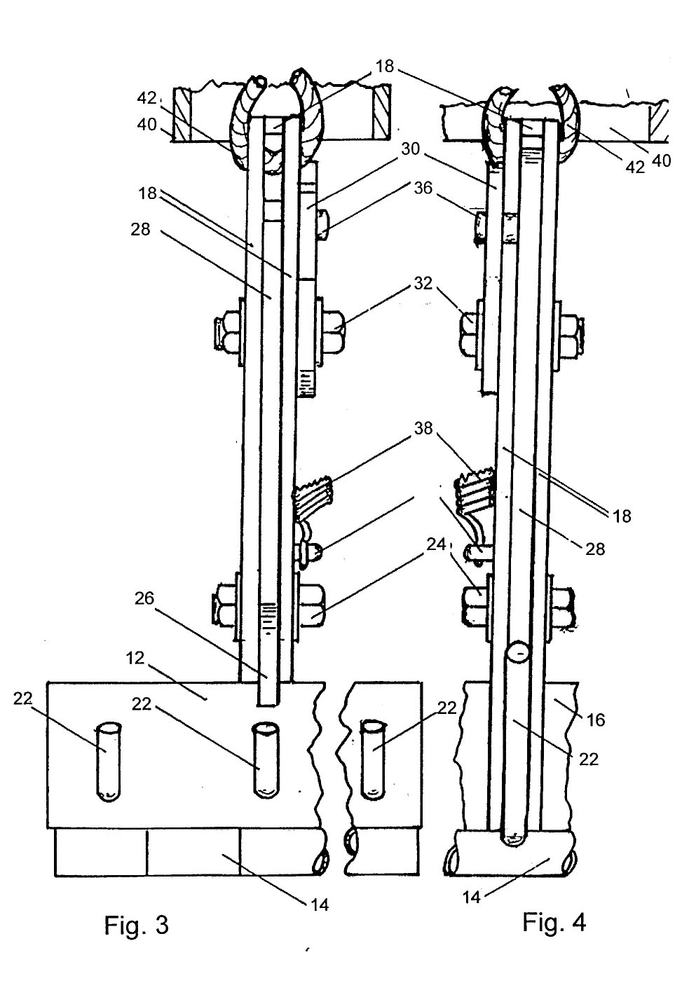

Referring to the drawings, FIGS. 1-4 illustrate a hoist assembly in accordance with the present invention. The hoist assembly 10 includes a front plate 12 that is attached via a hinge 14 to a back plate 16. The back plate is mounted to a frame 18 and a latch 20 is used to hold the front plate against the back plate. Both the front and back plates have fasteners 22 attached to them. In the illustrated embodiment, the fasteners are hooks, however, clamps, clips, pegs, rings, tethers, lanyards or other devices for attaching one item to another can also be used.

In one embodiment, the latch 20 is pivotably mounted 24 to the frame and includes a latch hook 26 and a counterweight arm 28. The latch hook can be used to hold the front plate against the back plate, however, in this position the pivot and the counterweight arm are configured to rotate and disengage the latch hook unless force is applied to prevent the rotation. The illustrated embodiment includes a latch lock 30 that can prevent the rotation of the counterweight arm, when the latch holds the front plate against the back plate. The latch lock is also pivotably mounted 32 to the frame and includes a notch 34 that is fashioned to house a latch locking pin 36 that protrudes from the counterweight arm. Both the notch and the latch locking pin are positioned so that the latch lock pin can fit within the notch when the latch hook is holding the front plate against the back plate.

The latch lock is spring loaded 38 to hold it in place when the latch pin is contained within the notch. The spring loading of the latch lock prevents the latch pin from disengaging from the notch and effectively locks the latch in position preventing the front plate from pivoting on its hinge. From a locked position, rotating the latch lock towards the back plate releases the counterweight arm, causing the latch hook to release the front plate to pivot on its hinge. Typically, gravity will cause the front plate to swing away from the backing plate until it comes to rest with the hooks on the front plate pointing downwards.

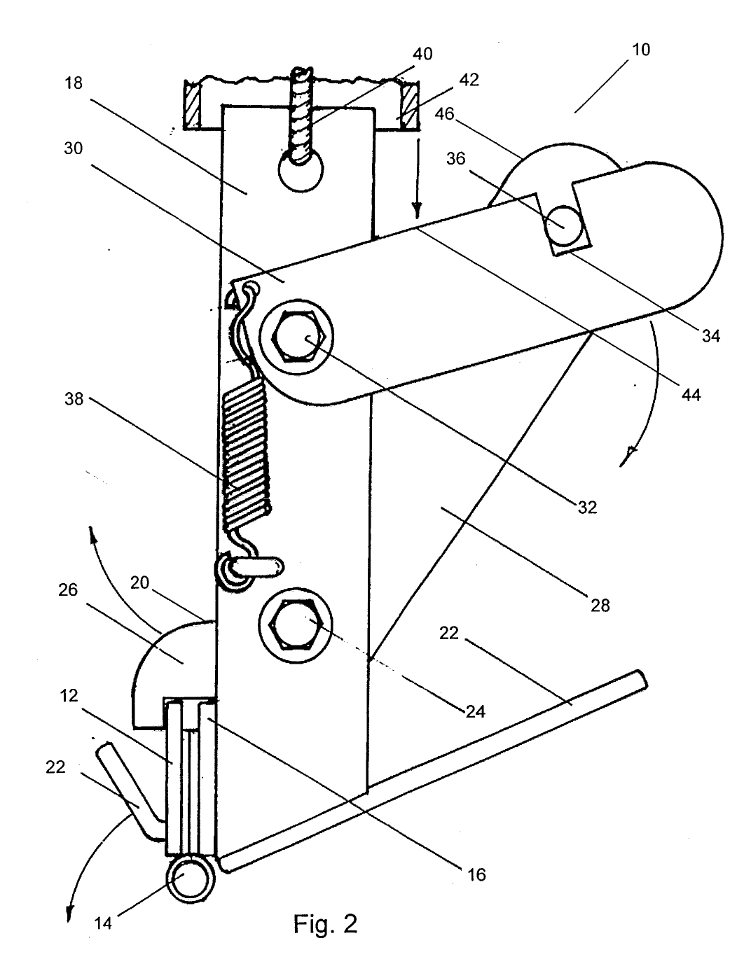

The side view of the hoist assembly in FIG. 2 shows the use of a descending tube 40 to release the latch lock. The hoist assembly can be raised and lowered using a cable or lanyard 42 attached to the frame. Threading the cable through a descending tube can provide a mechanism for releasing the latch lock. Drawing the hoist assembly inside the descending tube using the cable causes the tube to press down on the top surface 44 of the latch lock. When the force of the tube against the top surface of the latch lock overcomes the spring loading on the latch lock, the latch lock is forced to rotate towards the back plate releasing the latch pin and allowing the latch to rotate. As described above, the weight force on the counterweight arm 28 causes the latch to rotate. Drawing the hoist assembly further inside the descending tube can also cause the latch to rotate as the tube applies pressure to the top surface 46 of the counterweight arm.

In circumstances where a descending tube is used to release the latch lock in the manner described above, the diameter of the latch lock is typically chosen to accommodate the hoist assembly frame. The tube diameter can also accommodate the counterweight arm, when the latch is in the locked position, provided the counterweight arm is free to rotate once the latch lock is released. In other embodiments, the latch lock can be released by pulling on a cable attached to the latch lock or by using any other mechanism that applies a force to counteract the spring loading on the latch lock in a controlled manner.

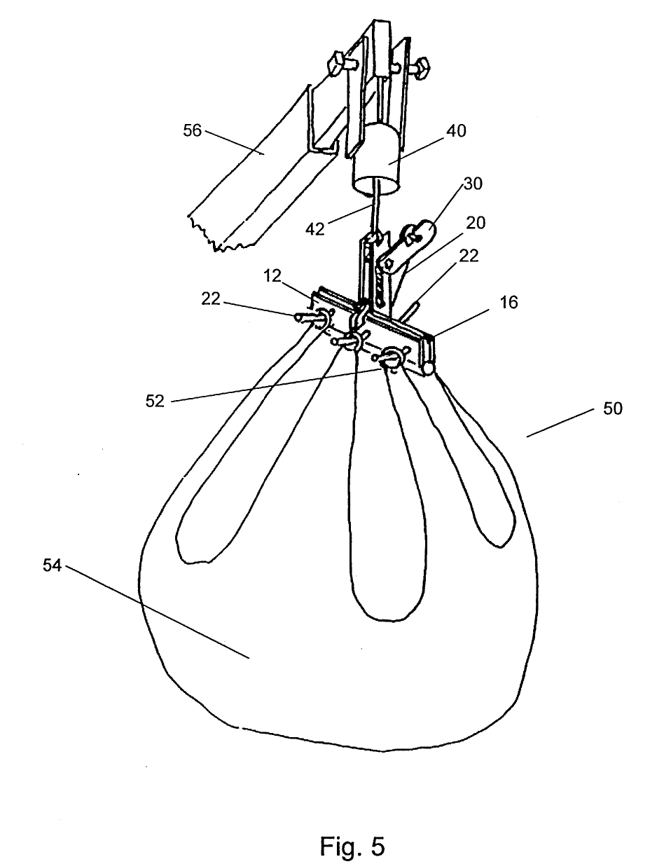

The perspective view in FIG. 5 shows the hoist assembly of FIG. 1 lifting an object using a tarpaulin 50. The hoist assembly has its latch lock 30 engaged so that the front plate 12 is held against the back plate 16 by the latch 20. The tarpaulin includes four rings 52 and the tarpaulin is suspended from the hooks on the front plate and the back plate of the hoist assembly using the rings. The configuration of the hooks and the rings forms the tarpaulin into a cradle 54 when it is suspended from the hoist assembly, which enables objects within the cradle to be lifted using the hoist assembly. The cradle formed by the tarpaulin also reduces the likelihood that an object cradled within the tarpaulin will accidently fall during the lift.

The hoist assembly illustrated in FIG. 5 is suspended from a crane arm 56 using a cable 42 that is threaded through a descending tube 40. When the hoist assembly is drawn inside the descending tube, the latch lock 30 releases the latch 20 and the front plate 12 is free to pivot on its hinge 14. The weight of the tarpaulin 50 suspended from the hooks on the front plate causes the front plate to rotate away from the back plate and as the front plate rotates, the rings 52 attaching the tarpaulin to the front plate slide from their hooks. As the rings slide from the hooks, the weight of the objects cradled in the tarpaulin and the rings that are still attached to the back plate of the hoist assembly cause the tarpaulin to unfurl, dumping objects that were cradled within the tarpaulin beneath the hoist assembly. The crane arm can then be used to maneuver the now empty tarpaulin suspended from the hooks on the back plate of the hoist assembly to another location.

The tarpaulin shown in FIG. 5 possesses four rings. In other embodiments, a tarpaulin possessing two or more rings can be used with the hoist assembly. In addition, the shape of the tarpaulin can be modified to increase the cradling effect created when the tarpaulin is suspended from the hoist assembly. The tarpaulin may also be in the form of a netting such as a cargo net.

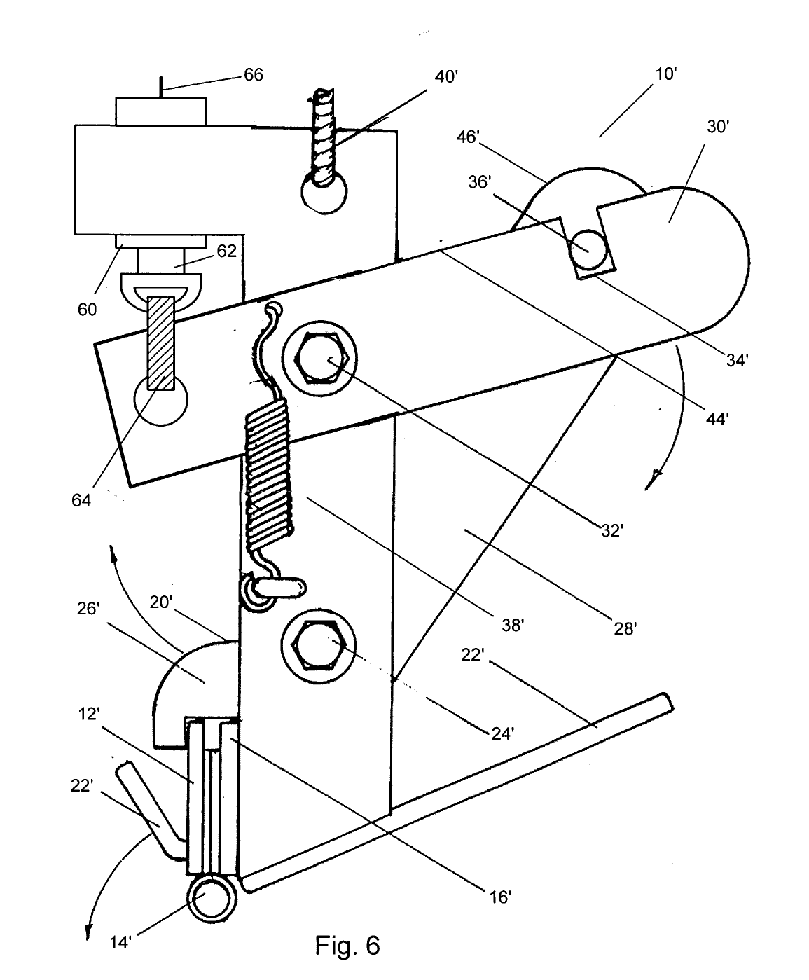

An embodiment of a hoist assembly in accordance with the present invention that uses a solenoid to release a latch lock is illustrated in FIG. 6. The hoist 10′ assembly is similar to the hoist assembly 10 illustrated in FIGS. 1-5 except that the position of the latch lock 30′ is controlled by a solenoid 60 as opposed to a spring. A rod 62 within the solenoid 60 is connected to the latch lock 30′ by a lanyard 64. When the solenoid 60 is energized, the magnetic field within the solenoid accelerates the rod 62 away from the latch lock 30′ causing the latch lock to be pulled up. When the solenoid is not energized, the latch lock 30′ can be positioned so that the latch 20′ cannot rotate and a tarpaulin can be secured from the fasteners on the front and back plates of the hoist assembly. In one embodiment, the energizing of the solenoid can be controlled by a control wire 66 connected to the solenoid.

In the illustrated embodiments, the release of the fasteners is achieved using the controlled release of the front plate to invert several of the hooks from which the tarpaulin is suspended. In other embodiments, other fasteners can be used with other mechanisms that enable the controlled release of a tarpaulin from the fasteners. In an embodiment that does not possess a latch or a pivoting front plate, the fasteners are implemented using pegs that can be removed using lanyards. In other embodiments, electrical or mechanical devices can be used to control the release of fasteners.

Although preferred embodiments have been described and illustrated, it is apparent from the foregoing that various changes may be made without departing from the invention. Accordingly, the scope of the invention should be limited only by the appended claims wherein what is claimed is:

What is claimed is:

1. A hoist assembly, comprising:
a frame;
two or more fasteners connected to the frame;
wherein at least one of the fasteners is configured for controlled release; and
wherein at least one of the fasteners is configured to not release when the other fasteners are released.

2. The hoist assembly of claim 1 wherein the frame comprises:
a back plate to which at least one fastener is attached;
a front plate pivotably attached to the back plate and to which at least one fastener is attached; and
a latch connected to the frame configured to hold the front plate against the back plate.

3. The hoist assembly of claim 2, further comprising a tarpaulin attached to the back plate and the front plate by the fasteners.

4. The hoist assembly of claim 3, wherein:
the fasteners are hooks;
the tarpaulin includes a plurality of rings; and
the rings suspend the tarpaulin from the hooks on the front plate and the back plate.

5. The hoist assembly of claim 4, wherein:
the front plate includes three hooks; and
the tarpaulin includes at least four rings.

6. The hoist assembly of claim 2, wherein:
the latch is pivotably connected to the frame and possesses a hook at one end that holds the front plate against the back plate; and
the frame includes a latch lock that is configured to immobilize the latch.

7. The hoist assembly of claim 6, further comprising:
a hoist arm having a sleeve; and
a lanyard extending through the sleeve and connected to the frame.

8. The hoist assembly of claim 7, wherein the sleeve is configured to release the latch lock when a portion of the frame is drawn inside the sleeve.

9. The hoist assembly of claim 6, wherein the latch lock is connected to a solenoid configured to controllably release the latch lock.

10. A hoist assembly, comprising:
a frame;
first and second fastening means attached to the frame for suspending a tarpaulin; and
means for controllably releasing the second fastening means.

11. A method of transporting an object, comprising:
placing the object on a tarpaulin;
fastening the tarpaulin to a hoist assembly;
hoisting the hoist assembly;
releasing some of the fasteners to enable the object to fall from the tarpaulin, while retaining the tarpaulin.

12. A hoist assembly for hoisting landscaping debris, comprising:
a frame;
two or more fasteners connected to the frame;
wherein at least one of the fasteners is configured for controlled release; and
wherein at least one of the fasteners is configured to not release when other fasteners are released.

13. The hoist assembly of claim 12 wherein the frame comprises:
a back plate to which at least one fastener is attached;
a front plate pivotably attached to the backing plate and to which at least one fastener is attached; and
a latch connected to the frame configured to hold the front plate against the back plate.

14. A hoist assembly, comprising:
a frame;
a back plate connected to the frame;
a front plate pivotably connected to the back plate;
a latch pivotably mounted on the frame and configured to secure the front plate against the back plate;
a latch lock pin connected to the latch;
a latch lock pivotably mounted on the frame and including a notch configured to contain the latch lock pin;
a solenoid connected to the frame and to the latch lock configured to controllably release the latch lock when the latch lock pin is contained in the notch;
at least one hook connected to the back plate; and
at least one hook connected to the front plate.
